(19) United States
(12) Patent Application Publication
(10) Pub. No.: US 2014/0254042 A1
(43) Pub. Date: Sep. 11, 2014

(54) DYNAMIC ALLOCATION OF LBA TO UN-SHINGLED MEDIA PARTITION

(71) Applicant: SEAGATE TECHNOLOGY LLC, Cupertino, CA (US)

(72) Inventors: Hoe Pheng Yeo, Singapore (SG); Bimas Winahyu Aji, Singapore (SG); Wen Xiang Xie, Singapore (SG); Sundar Poudyal, Boulder, CO (US)

(73) Assignee: SEAGATE TECHNOLOGY LLC, Cupertino, CA (US)

(21) Appl. No.: 13/788,032

(22) Filed: Mar. 7, 2013

(51) Int. Cl. G11B 20/12

(52) U.S. Cl. CPC G11B 20/1217
USPC 360/48

(57) ABSTRACT

In a shingled magnetic recording system, LBA can be dynamically allocated to an un-shingled media partition (UMP) based on a usage metric. In one implementation, the usage metric depends upon the frequency of writes to storage region and/or upon how recently the storage location has been written to. Data corresponding to one or more LBA ranges within a shingled data region may be rewritten to a storage region within a UMP on the disk.

### BACKGROUND

Shingled magnetic recording allows for increased cell density, but generally entails re-writing an entire band of shingled data when one or more cells within the band are changed. Such excess writes to unchanged cells are time consuming and an inefficient use of power within a magnetic storage drive.

### SUMMARY

Implementations described and claimed herein provide for dynamically allocating data stored in a shingled data region of a magnetic media to an unshingled data region of the magnetic media.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following Detailed Description.

### BRIEF DESCRIPTIONS OF THE DRAWINGS

FIG. 1 illustrates an example data allocation system with a magnetic media disc including an un-shingled media partition (UMP) situated between two sections of shingled data.

FIG. 2 illustrates another example data allocation system with a magnetic media disc and an logical block address (LBA) usage processing unit.

FIG. 3 illustrates an example diagram for dynamically updating data stored within a UMP on magnetic media disc having one or more regions of shingled data.

FIG. 4 is a flowchart of example operations of a system for dynamic allocation of LBA to a UMP on a magnetic media disc.

FIG. 5 discloses a block diagram of a computer system suitable for implementing one or more aspects of a system for dynamically allocating LBA to a UMP on a magnetic media disc.

### DETAILED DESCRIPTION

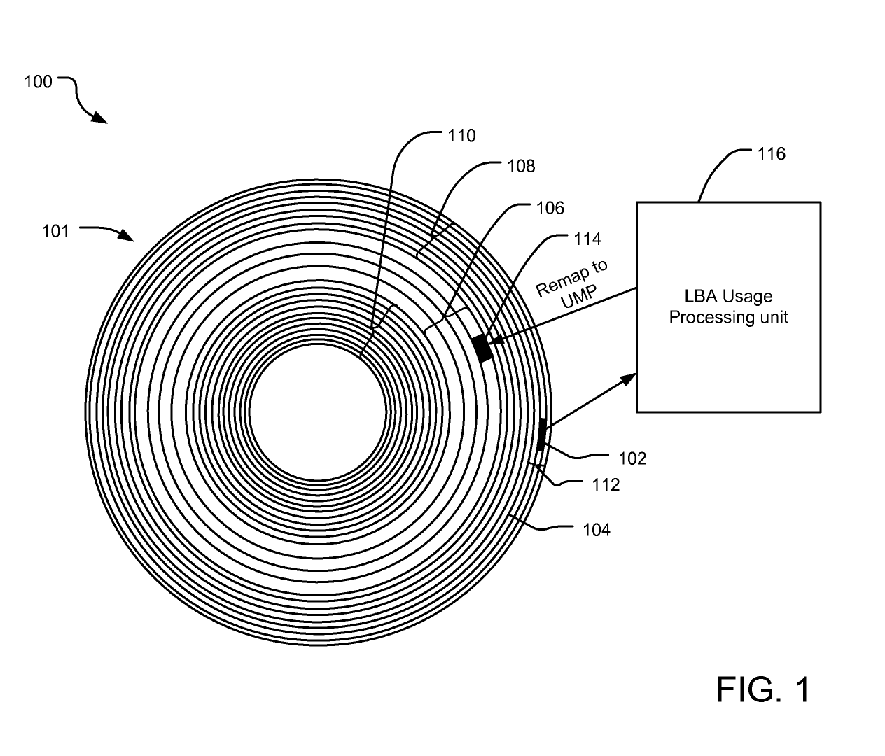

Magnetic media storage drives store data in polarized cells on one or more magnetized media within each storage drive. One example of a magnetic media storage drive is a magnetic disc drive, which includes a disc (e.g., disc 101 of FIG. 1) that has polarized cells arranged in concentric, generally circular data tracks. In operation, one or more of the discs rotate at a constant high speed within the storage drive while information is written to and read from the tracks on the disc(s) using an actuator assembly. The actuator assembly rotates during a seek operation about a bearing shaft assembly positioned adjacent the discs.

The actuator assembly includes one or more actuator arms that extend toward the discs. A head with a read pole and a write pole is mounted at the distal end of each of the actuator arms. The write pole generates a magnetic field that writes data to a disc by changing the magnetic polarization of the cells on the disc that rotates beneath the head. The read pole reads data from the disc by detecting the magnetic polarization of the cells on the disc.

In non-shingled magnetic media, each of the cells on a magnetized medium are of a sufficiently large size relative to the size of the write pole to allow the write pole to write data to the cells without overwriting data in any surrounding cells. As a result, data may be randomly written to available cells anywhere on the magnetic medium. However, as requirements for data storage density increase for magnetic media, cell size decreases. A commensurate decrease in the size of the write pole is difficult because a strong write field gradient provided by a larger write pole is often required to shift the polarity of the cells on the magnetized medium. As a result, writing data to smaller cells on the magnetized medium using the relatively larger write pole may affect the polarization of adjacent cells (i.e., overwriting the adjacent cells). One technique for adapting the magnetic medium to utilize smaller cells while preventing adjacent data being overwritten during a write operation is shingled magnetic recording (SMR).

SMR utilizes a large strong write field generated by the write pole. One constraint of shingled magnetic recording is that when data is written to the magnetic media, it is written in sequentially increasing or decreasing radius tracks. The strong write field affects two or more adjacent tracks including the track being written to and one or more previously-written tracks. As a result, in order to change any data cell within the shingled data, all of the shingled data is re-written in the selected sequential write order.

In order to achieve the increased cell density made possible by SMR while compensating for a lack of random write functionality in such a system, one or more isolation regions may be created within with shingled data. The isolation regions, also referred to as guard tracks, are groupings of one or more adjacent data tracks within the shingled data that are unavailable for recording. In operation, the isolation regions define separate data bands (i.e., groups of logical sectors bounded by guard tracks) of shingled data. Typically, each guard track is wide enough to prevent any overwriting across the guard track. As a result, the guard tracks create bands of shingled data, including one or more adjacent tracks, that are isolated from other bands. Consequently, a single band of shingled data is rewritten (rather than all of the shingled data on the disk) when one or more cells within the band are changed.

However, re-writing one or more cells of data in a data band still typically entails multiple steps, including: reading the entire data band, writing data of the data band into a media scratch pad (e.g., a temporary cache) on a disc, reading the data from the media scratch pad, and re-writing the data to the original data band with the one or more changed cells. Consequently, shingled data write operations are typically more time consuming and less power efficient than un-shingled data write operations.

To address the needs for both increased cell density and storage and also for time and power efficiency, discs may have variable-spacing between data tracks, with some tracks spaced far enough apart to permit for random, non-shingled data writing. Thus, these discs have bands of shingled data and one or more bands of un-shingled data, which shall hereinafter be referred to as un-shingled media partitions (“UMPs”). UMPs are generally allocated statically to a set range of logical block addresses (LBAs) on the disc. However, SMR systems with UMP capacity could be more power and time efficient if the LBAs written to most frequently could be selectively mapped to the UMP. Thus, the presently disclosed technology allows for dynamically allocating LBAs to a UMP based on a usage metric. The usage metric may depend, among other factors, upon a prior write frequency to a given storage location and/or the recency of a prior write operation to the storage location. This SMR technology may also be used in other types of storage devices such as memory cards, universal serial bus (USB) flash drives, solid-state drives, etc.

FIG. 1 illustrates an example data allocation system 100 with a magnetic media disc 101 of a storage device (not shown). The magnetic media disc 101 includes a UMP region 106 situated between two sections (e.g., circular groups of adjacent data tracks) of shingled data 108 and 110. Each of the sections of shingled data (i.e., the shingled data sections 108 and 110) and unshingled data (i.e., the UMP region 106) includes several data tracks (e.g., a data track 104). One or more of the data tracks in the shingled data regions (i.e., SMR regions) 108 and 110 may be guard tracks, to which no data is written. These guard tracks further separate each of the sections of shingled data 108 and 110 into bands (e.g., a band 112), where each band includes one or more data tracks. A write command sent by a host device (not shown) may include start and stop LBA and data length information indicating positions where a writer (not shown) of the storage device is to start and stop a write operation.

Each time data is written to a range of LBAs corresponding to a storage location within a shingled data region (e.g., 108 or 110), one or more bands of data corresponding to the storage location are re-written. For example, a host computer may send a write command to the storage device to write to a range of LBAs corresponding to a data region 102. The data region 102 falls within a band of data 112, which includes three data tracks. Other data bands on the disc may contain a different number of data tracks (e.g., one data track, five data tracks, eight data tracks, etc.). In this case, the storage device responds to the write command by reading and copying all of the data in the data band 112 (e.g., the band where data region 102 is located) to a media scratch pad (not shown). In one implementation, the media scratch pad is a static region of the media disc 102. In another implementation, the media scratch pad is in a volatile memory or SSD memory. After the data band 112 is copied to the media scratch pad, the data is read back from the media cache and re-written to the data band 112, incorporating the new data associated with the write command and corresponding to the data region 102.

An LBA Usage Processing Unit 116 tracks the frequency of writes to each of the data bands on the disc 100 and identifies which data bands are “hot storage locations.” As used herein, the term “hot storage location” shall refer to a storage location (such as an LBA range or a data band consisting of one or more adjacent data tracks) for which a calculated usage metric exceeds an established static or dynamic threshold (i.e., the usage metric threshold). In one implementation, the usage metric of a storage location is a value indicative of computation and/or power efficiency savings that may be attained by including data corresponding to the storage location within the UMP region 106. The usage metric may be based on a number of factors such as, for example, the frequency of write operations to the storage location and/or the recency of the last write operation to the storage location.

The LBA Usage Processing Unit 116 maps the identified hot storage locations to one or more LBA regions in the UMP 106 and also copies data associated with the hot storage locations to the one or more to the mapped LBA ranges in the UMP 106. For example, the LBA Usage Processing Unit 116 may determine that the data region 102 in band 112 is written to every single morning. The reason for this could be that a user of a host computer goes to her favorite webpage every morning at the same time, and a cookie is written to the data region 102. Another reason for this could be that the user's email data is routinely backed up to the data region 102 every morning at 7:00 am. Consequently, the LBA Usage Processing Unit 116 identifies the data band 112 as a hot storage location and maps an LBA range corresponding to the hot data band to another storage region in the UMP 106, so that the data previously saved in the data band 112 can be saved within the UMP 106.

In another implementation, the LBA Usage Processing Unit 116 identifies the data region 102 as a hot storage location (rather than the entire data band 112) and maps the LBA range corresponding to the storage location 102 to another storage region in the UMP 106.

The UMP region 106 can be written to randomly. Thus, a correction to a data band stored in the UMP 106 does not require re-writing the entire data band. Consequently, data stored in the UMP 106 can be re-written with greater efficiency than data stored within the SMR regions 108 and 110. Moreover, storing frequently and/or recently written data bands or data regions in the UMP 106 reduces overall power consumption of the storage device.

In some instances, it may be desirable to remove previously-identified hot data from the UMP region 106. For example, previously-identified hot data may be removed from the UMP region 106 if the frequency of writes to associated data cells in the UMP region 106 decreases substantially over time. Thus, the LBA Usage Processing Unit 116 may periodically recalculate the usage metric for various storage locations within the SMR regions 108 and/or 110 to ensure that data stored in the UMP 106 corresponds to currently-identified hot storage locations. At such times, data of newly-identified hot storage locations (i.e., new hot data) can be added to the UMP 106 and/or data stored in the UMP corresponding to storage locations that are no longer “hot” (e.g., old hot data) can be removed from the UMP 106. In some instances, old hot data can be replaced with new hot data.

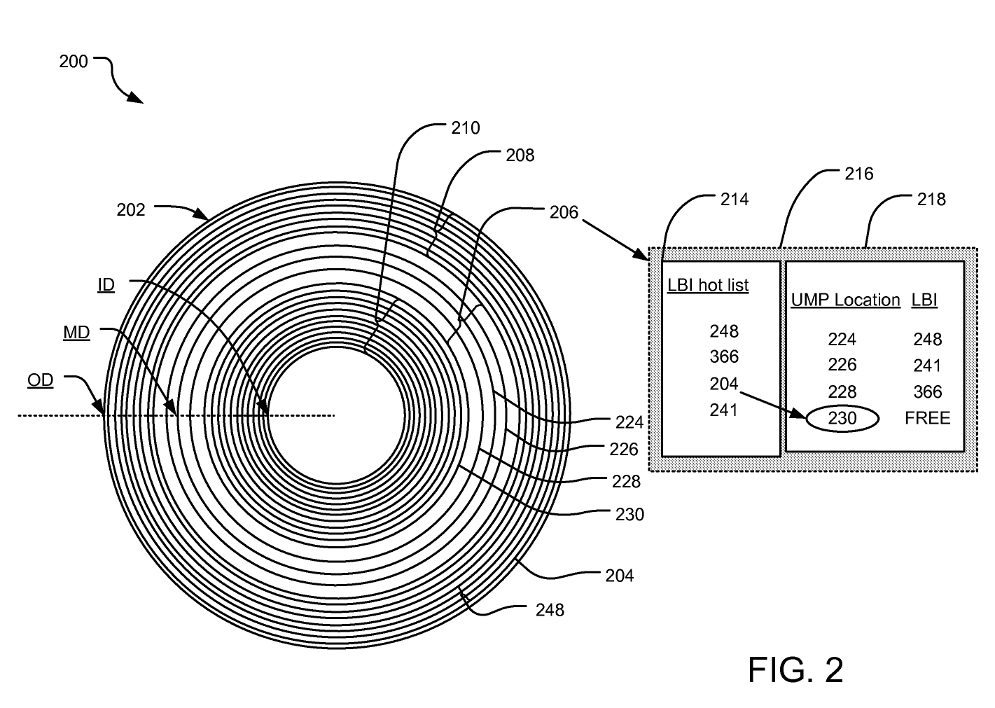

FIG. 2 illustrates an example data allocation system 200 with a magnetic media disc 202 of a storage device (not shown). The magnetic media disc 202 has a UMP region 206 located between sections of shingled data 208 and 210. The magnetic media disc 202 includes several circular tracks (e.g., a track 204) spaced across the disc. The spacing between the tracks varies across the disc. In one implementation, the spacing between tracks decreases moving from the middle diameter of the disc MD to the outer diameter of the disc OD, and also from the middle diameter MD to the inner diameter ID. The spacing is such that the tracks in the UMP region 206 are spaced far enough apart that the write field of the writer of the storage device does not affect more than one track at a time when writing to the UMP region 206. Therefore, data within the UMP region 206 can be written to randomly and sectors within the UMP 206 can be updated in response to a write operation without causing a rewrite of other sectors that are otherwise unaffected by the write operation.

An LBA Usage Processing Unit 216, which may be a functional module of a drive's firmware executed on a processor of a host computer, tracks information related to a usage metric for a number of storage locations. The usage metric of a storage location (e.g., a data band or other LBA range not corresponding to the start and end sectors of a data band) may be calculated based on a number of factors including, for example, the frequency of write operations to the storage location and/or the recency of the last write operation to the storage location. The LBA Usage Processing Unit 216 calculates a usage metric for number of storage locations in the SMR regions 208 and/or 210, and identifies one or more “hot storage locations” based on this calculation. The hot storage locations are mapped and written to the UMP region 206 so that data of the hot storage locations is stored within the UMP region 206 rather than in the SMR regions 208 and/or 210. After such data is written to the UMP region 206, the redundant data in the SMR region 208 or 210 can be overwritten with other data.

In one implementation, the usage metric of a storage location is based on the frequency of writes to the storage location. Here, the storage location may be identified as a hot storage location if the number of writes to that storage location exceeds a pre-established threshold. For example, a data band may have a usage metric that satisfies the threshold if the data band is written to three or more times on average for three consecutive weeks.

In the same or an alternate implementation, the usage metric of a storage location is based on how recently data was written to the storage location. Here, the storage location may be identified as a hot storage location if at least one write to the storage location satisfies a recency requirement. For example, a storage location may have a usage metric that satisfies the recency requirement if the storage location has been written to in the past 48 hours.

In each of the implementations disclosed herein, usage metric threshold parameter values (such as the frequency threshold and/or recency requirement values) may vary according to desired design criteria.

In another implementation, the LBA Usage Processing Unit 216 determines the usage metric of a storage location based on multiple frequency thresholds. For example, a storage location may be designated a hot storage location if it has been accessed a set number of times this week and a set number of times over the past month.

In yet another implementation, the LBA Usage Processing Unit 216 is optimized to ensure that there are few or no unused data cells in the UMP 206. For example, the LBA processing unit 216 may rank a number of storage locations in SMR regions according to a usage metric for each storage location (e.g., most frequently and/or recently accessed) and designate as ‘hot’ a select number of the storage locations with the most-highly ranked usage metric, where the select number is set to ensure that the UMP region 206 is filled to at or near a maximum capacity.

In yet another implementation, the I/O requirements of a write operation are factored into the usage metric. For example, the LBA Usage Processing Unit 216 may identify high I/O write tasks frequently written to the same LBA ranges. Here, storage locations corresponding to such LBA ranges may be designated as hot and remapped to the UMP region 206.

A hot storage location identified by the Usage Processing Unit 216 may be one or more data bands. In one such implementation, a usage metric is calculated for all data bands in the SMR regions 208 and 210 on the media disc 202. The Usage Processing Unit 216 identifies a select number of data bands as hot storage locations to be mapped to the UMP region 206.

A hot storage location identified by the Usage Processing Unit 216 may also be an LBA range (rather than an entire data band). Thus, the LBA range may have start and end sectors that do not correspond to the beginning and ending of a data band. In such cases, data corresponding the hot storage locations (i.e., the LBA ranges) may be mapped to the UMP 206. This data may be removed from or otherwise overwritten in its original location (the actual LBA range) within a band of shingled data.

The LBA Usage Processing Unit 216 also dynamically updates the UMP region 206 to reflect changes in the usage metric for each of the monitored storage locations in the SMR regions 108 and 110. For example, old hot data in the UMP region 206 may occasionally be removed or overwritten with new hot data. In the implementation illustrated, the LBA Usage Processing Unit 216 creates a hot list 214 that includes currently-identified hot storage locations (e.g., Logical Band Indices (LBIs) corresponding to one or more SMR regions 208 and 210) based on a usage metric. In this case, these hot storage locations are bands of data with a usage metric satisfying a given threshold. This threshold may be static or dynamic.

The LBA Usage Processing Unit 216 may create the hot list 214 (and thus recalculate the usage metric for a number of storage locations) in response to one or more timer-based events. In one implementation, the LBA Usage Processing Unit 216 includes a timer and firmware and the timer is started when the LBA Usage Processing Unit 216 detects that the storage device has received a command from a host. This “host-active” timer is programmed to interrupt the firmware periodically at a set every time interval, such as every 250 milliseconds. The firmware, when interrupted by the timer, will then recalculate the usage metric for a number of storage locations (e.g., in one implementation, for all of the data bands) and determine which storage locations have a usage metric exceeding a set threshold (i.e., determine which storage locations are hot storage locations).

In another implementation, the LBA Usage Processing Unit 216 includes a timer and firmware and the timer is started when the LBA Usage Processing Unit 216 detects that the storage device is in an idle mode and that no host command has been received for a set period of time, such as 500 milliseconds. This “host idle” timer is programmed to interrupt the firmware periodically at a set time interval, such as every 250 milliseconds. The firmware, when interrupted by the timer, will then recalculate the usage metric for a number of storage locations and determine which storage locations have a usage metric exceeding a set threshold.

In another implementation, the LBA Usage Processing Unit 216 includes a “host active” timer that begins when the host has been active for a period of time, and also includes a “host idle” timer that begins when the host has been idle for a period of time. Each of the host active and host idle timers are programmed to interrupt firmware at set intervals (which may be different from one another) to determine whether the usage metric for various storage locations on the disk exceeds a threshold value. A higher threshold value may be set for data written while the host is active than while the host is idle. For example, storage locations written to while the host is active may have to be written to with a greater frequency to be designated as hot storage locations than other storage locations written to while the host is idle.

As discussed above, a storage location may be considered a “hot storage location,” if it has a usage metric that exceeds an established threshold value. In one implementation, this usage metric threshold value is dynamically varied to ensure that storage space in the UMP region 206 is prioritized for data regions that are the most frequently written to. For example, the usage metric may be based on a frequency of writes, wherein a data band is considered a hot storage location if it is written to once per day. If there are a large number of data bands that are written to once per day, there may not be enough storage space in the UMP region 206 to store the data corresponding to each of the data bands with a usage metric exceeding the set threshold. In such a situation, the LBA Usage Processing Unit 216 may dynamically alter the usage metric threshold so that data bands be designated as “hot data bands” if they are written to at least twice per day.

Alternatively, the LBA Usage Processing Unit 216 may rank a number of storage locations in descending order of a calculated usage metric and select a number of the most highly-ranked storage locations to be designated as hot storage locations. Data corresponding to these hot storage locations is then written to the UMP region 206. This selected number of storage locations may be dynamically varied to ensure that the UMP region 206 is filled to a desired data capacity.

To determine which data should be added to the UMP region 206, the LBA Usage Processing Unit 216 may compare currently-identified hot storage locations to previously-identified hot storage locations (i.e., those regions currently mapped to the UMP region 206). In the example implementation shown, the LBA Usage Processing Unit 216 has created the hot list 214 that includes Logical Band Indices (LBIs) of data bands with a usage metric satisfying an established threshold. The LBA Usage Processing Unit 216 has also created a UMP table 218 that includes the LBI of each data band currently-mapped to the UMP region 206 and an associated UMP location where data corresponding to each listed data band is stored.

In the example illustrated, the LBI 248 appears in the UMP table 218. The LBI 248 is a data band in an SMR region 208 or 210, encompassing a range of LBAs (not shown). Data corresponding to this LBI 248 is now stored within the UMP 206 at a UMP location 224. Similarly, LBIs 241 and 366 are previously-identified hot data bands mapped to the UMP locations 226, and 228, respectively.

The hot list 214 includes some data bands that have been previously-identified as hot storage locations (i.e., LBIs 248, 366, and 241). However, the hot list 214 also includes a newly-identified hot storage location (i.e., a data band with an LBI 204). The LBA Usage Processing Unit 216 identifies a free location 230 in the UMP region 206 with enough space to store the data corresponding to LBI 204. Data corresponding to the newly-identified hot storage location (i.e., the LBI 204) is then written to the UMP location 230. The UMP location 230 is a range of LBAs within the UMP region 206, which may or may not be consecutive sectors.

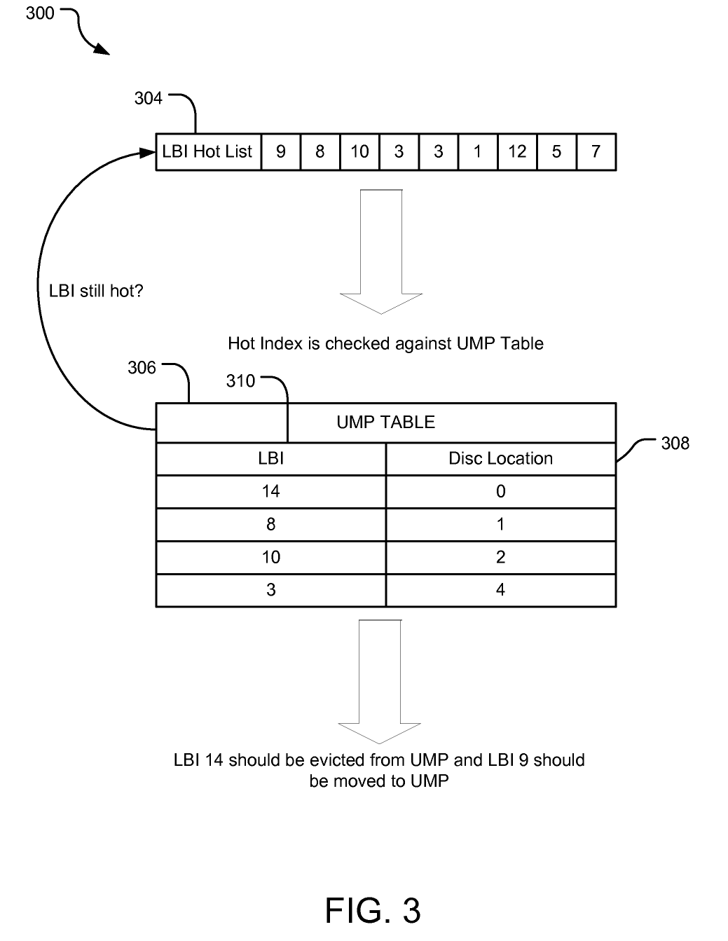

FIG. 3 illustrates an example diagram 300 for dynamically updating data stored within a UMP on a magnetic media disc having one or more regions of shingled data. An LBA Usage Processing Unit (not shown), which may be a functional module of a drive's firmware, creates an LBI hot list 304 based on a usage metric calculated for a number of data bands on the media disc. In one implementation, the usage metric is defined by a weighted combination of a recency parameter (e.g., how recently data has been written to the data band) and a frequency parameter (e.g., how frequently data in the data band is written to). In other implementations, the usage metric is defined by any combination of frequency parameters, recency parameters, storage space parameters (e.g., how much space is available in the UMP), I/O requirements for individual write tasks commonly written to each data band, etc. In the implementation shown, the LBI hot list 304 includes data bands 9, 8, 5, 3, 1, 12, 10, and 7 that have been identified as hot storage locations. The hot list 304 may be generated periodically, at set intervals, or in response to one or more timer-based events.

The LBI hot list 304 is checked against a UMP table 306. The UMP table 306 includes LBIs previously designated as hot storage locations (e.g., an LBI listing 310), and an associated disc location in the UMP (i.e., a UMP Location 308) for each listed LBI. Each LBI listed in the UMP table 306 corresponds to a range of LBAs in the shingled data on the magnetic media disc. Data previously stored at each of these LBA ranges has been moved to a UMP location (shown by column 308). In this case, the LBIs 8, 10, and 3 appear in the UMP table 306 also still appear in the LBI hot list 306. However, the top-ranked LBI (i.e., LBI 9) in the LBI hot list 304 does not appear in the current UMP table. Therefore, the LBA Usage Processing Unit determines data corresponding to LBIs 8, 10, and 3 should be retained in the UMP and in the UMP table 306, and also determines that data corresponding to the LBI 9 should be added to the UMP and to the UMP table 206.

In this case, the UMP table 306 indicates that the UMP is full and there is no available space in the UMP to store the data corresponding to LBI 9. Therefore, some data must be evicted from the UMP to make room for the data corresponding to LBI 9. Accordingly, the LBA Usage Processing Unit searches for and identifies data bands stored in the UMP table that are no longer considered to be hot storage locations (i.e., bands that no longer appear on the LBI hot list 304). The LBA Usage Processing Unit identifies LBI 14 as a data band that no longer appears on the LBI hot list 304. Therefore, it is evicted from the UMP so that data corresponding to the data band 9 can be written to the UMP in place of the data from data band 14. The data from data band 14 is then re-written to a shingled data region, such as its original location (data band 14) or another location. The data corresponding to LBI 9 is written to the UMP at a disc location ‘0’.

In one example implementation, the physical location of data in the UMP is swapped with data in a newly-identified hot band. For example, the data corresponding to LBI 14 may be mapped to LBI 9 in a shingled data region, and the data corresponding to LBI 9 may be written to the UMP at the disc location ‘0’.

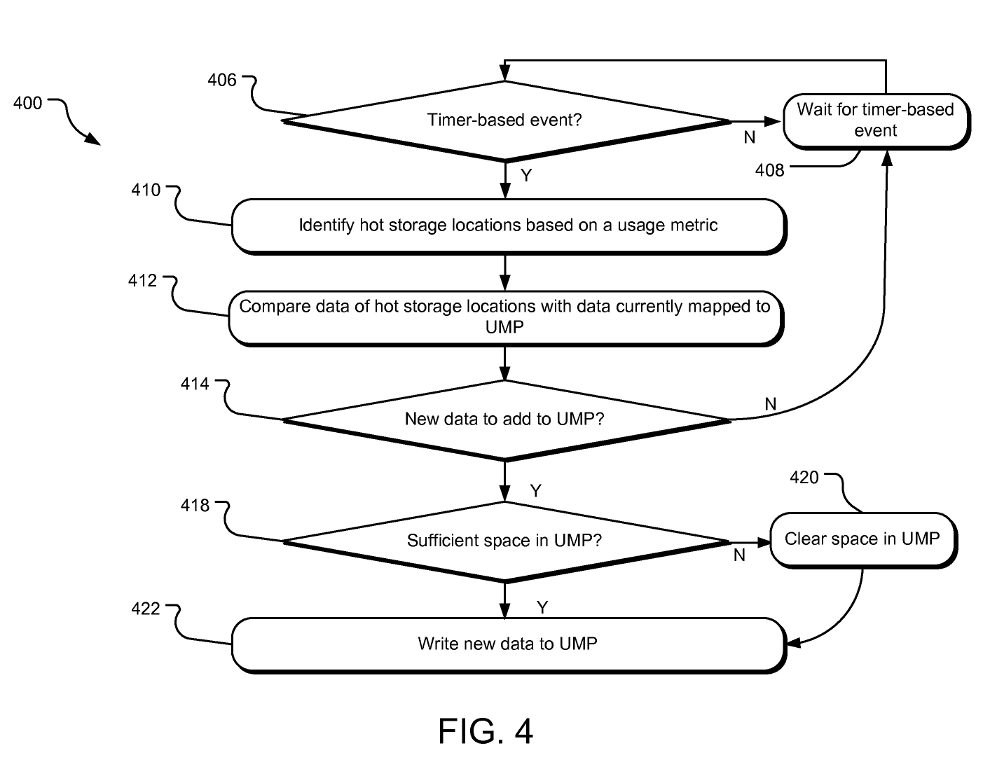

FIG. 4 is a flowchart of example operations of a system for dynamic allocation of LBA to a UMP on a magnetic media disc. A first timer-based determination operation 406 determines whether a timer-based event has occurred. In one implementation, the timer-based event is triggered when a host command is sent to a storage device. In another implementation, the timer-based event is triggered when a host device has been idle for a given period of time. In the same or another implementation, the timer-based event may be retriggered automatically in a set period of time, such as 250 milliseconds.

If the timer-based event has not been triggered, a waiting operation 408 executes a wait that continues until the timer-based even is triggered.

If the timer-based event has been triggered, a hot storage location identification operation 410 identifies hot storage locations (e.g., data bands or other LBA ranges) based on an LBA usage metric calculated for a number of storage locations within one or more unshingled data regions of a media disc.

The hot storage location identification operation 410 identifies storage locations with a usage metric at or above a pre-established threshold as hot storage locations. Data corresponding to these hot storage locations is to be included in the UMP region of the magnetic media. The pre-established threshold may be static or dynamic and/or variable based on the type of timer-based event that triggered the hot data band identification operation 410.

In one example implementation, the hot storage location identification operation 410 calculates the usage metric for all data bands on the media disc. The data bands having a usage metric that exceeds a pre-established threshold are identified as hot storage locations.

In another implementation, the hot storage location identification operation 410 calculates a usage metric for a number of individual LBA ranges (which may or may not correspond to the beginning and end of a given data band) according to the usage metric. For example, the hot data band identification operation 410 may identify a small LBA range within a large SMR data band that is frequently written to. The LBA range has a usage metric that exceeds a pre-established threshold so it is identified as a hot storage location.

A comparison operation 412 compares data corresponding to the one or more identified hot data locations with data currently stored in the UMP to determine whether data corresponding to the identified hot storage locations should be added to the UMP. For example, the comparison operation 412 may compare the LBAs of data currently stored in the UMP to LBAs of data corresponding to the identified hot storage locations.

Based on the comparison, a determination operation 414 determines whether new data is to be added to the UMP. If all data corresponding to the identified hot storage locations is already included in the UMP, the determination operation 414 determines that no new data is to be added to the UMP. In this case, a waiting operation 408 executes a wait until another timer-based event 406 occurs.

If the data comparison operation 412 identifies data corresponding to the identified hot storage locations that is not yet included in the UMP, then the new determination operation 414 determines that this data (i.e., new hot data) is to be added to the UMP.

A space-determining operation 418 determines whether there is sufficient storage space in the UMP to store the new hot data. If there is sufficient storage space, then the new hot data is written to the UMP by a data write operation 422. The storage space within the hot data bands (e.g., in the shingled data region) may be freed up to store additional data.

If there is insufficient space in the UMP to store the new data, then a space clearing operation 420 clears data from the UMP. In one implementation, the clearing operation 420 determines which data to clear by identifying data in the UMP that no longer corresponds to any of the identified hot storage locations. For example, the space clearing operation 420 may identify data in the UMP that has not been accessed for several weeks. This data is identified as data that can be cleared from the UMP (i.e., old hot data). After identifying the old hot data, the space clearing operation 420 clears the old hot data from the UMP.

In one implementation, the space clearing operation 420 clears the old hot data from the UMP by moving the old hot data from the UMP to a region of shingled data on the media. Such operation may require reading the old hot data, writing the old hot data to a temporary cache, and then re-writing the old hot data to consecutive sectors within the shingled data region of the media. The old hot data may be written to its original storage location (i.e., the location corresponding to LBAs of the old hot data) or a different location. For example, the old hot data may be written to the LBA range corresponding to the new hot data, thus “swapping” the positions of the new hot data and the old hot data.

Once the clearing operation 420 clears sufficient space in the UMP to receive the new hot data, then the new hot data is written via a write operation 422 to the UMP. This new hot data can then be written to more quickly and in a manner that utilizes less electrical power than required to write data to the shingled data region. In one implementation, the clearing operation 420 clears space in the UMP at a time of low or minimal activity in the storage device to provide for efficient utilization of resources.

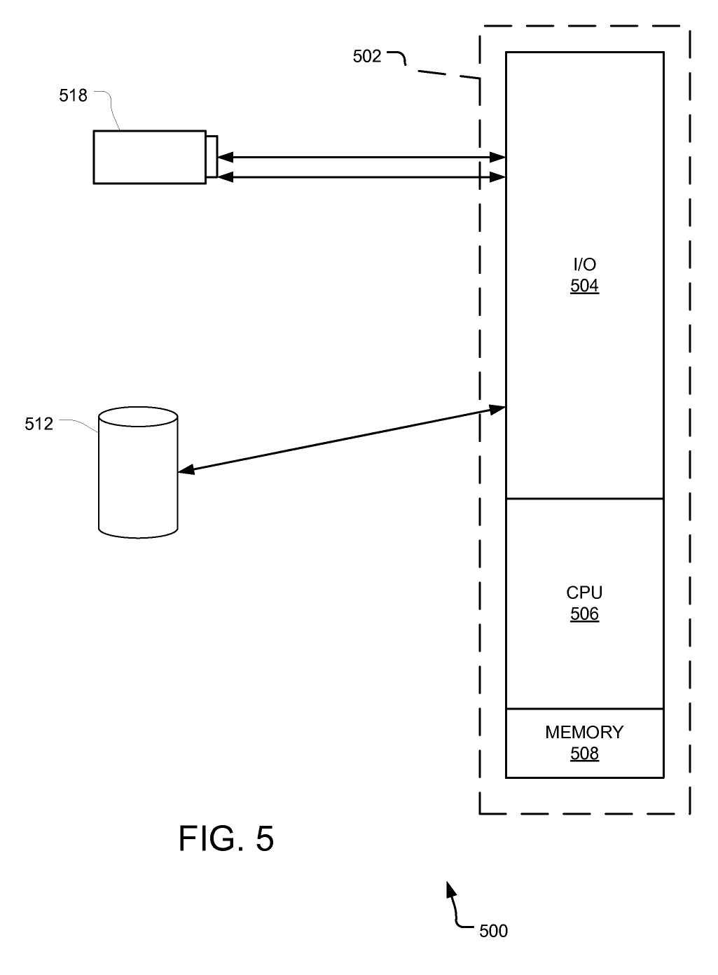

FIG. 5 discloses a block diagram of a computer system 500 suitable for implementing one or more aspects of a system for dynamically allocating LBA to a UMP on a magnetic media disc. In one implementation, the computer system 500 is used to implement a host server that calculates a usage metric for a number of shingled bands on the media and dynamically allocates LBA of those bands to the UMP.

The computer system 500 is capable of executing a computer program product embodied in a tangible computer-readable storage medium to execute a computer process. The tangible computer-readable storage medium is not embodied in a carrier-wave or other signal. Data and program files may be input to the computer system 500, which reads the files and executes the programs therein using one or more processors. Some of the elements of a computer system are shown in FIG. 5, wherein a processor 502 is shown having an input/output (I/O) section 504, a Central Processing Unit (CPU) 506, and a memory section 508. There may be one or more processors 502, such that the processor 502 of the computing system 500 comprises a single central-processing unit 506, or a plurality of processing units. The computing system 500 may be a conventional computer, a distributed computer, or any other type of computer. The described technology is optionally implemented in software loaded in memory 508, a disc storage unit 512, or removable memory 518.

In an example implementation, an LBA Usage Processing Unit that dynamically allocates LBA to UMP may be embodied by instructions stored in memory 508 and/or the storage unit 512 and executed by the processor 507. Further, local computing system, remote data sources and/or services, and other associated logic represent firmware, hardware, and/or software which may be configured to adaptively distribute workload tasks to improve system performance. The LBA Usage Processing Unit may be implemented using a general purpose computer and specialized software (such as a server executing service software), and a special purpose computing system and specialized software (such as a mobile device or network appliance executing service software), or other computing configurations. In addition, program data, such as dynamic allocation threshold requirements and other information may be stored in the memory 508 and/or the storage unit 512 and executed by the processor 502.

The implementations of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, adding and omitting as desired, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method comprising:
dynamically allocating data stored in a shingled data region of a magnetic medium to an unshingled data region of the magnetic medium.

2. The method of claim 1, further comprising:
identifying the data to dynamically allocate based on a frequency of writes to a logical block addressing (LBA) range associated with the data.

3. The method of claim 1, further comprising:
identifying the data to dynamically allocate based on a recency of a write operation performed to an LBA range associated with the data.

4. The method of claim 1, wherein dynamically allocating the data further comprises:
writing the data to an unshingled data storage location.

5. The method of claim 1, wherein dynamically allocating the data further comprises:
mapping an LBA range corresponding to an unshingled data region to an LBA range corresponding to a shingled data region.

6. The method of claim 4, wherein dynamically allocating the data further comprises:
writing data stored in the unshingled data storage location to a shingled data storage location.

7. The method of claim 1, wherein the data corresponds to a first LBA range and dynamically allocating the data further comprises:
writing data stored in the unshingled storage location to the first LBA range.

8. The method of claim 1, wherein the data is dynamically allocated in response to a timer-based event.

9. A system comprising:
a magnetic medium having at least one shingled data region and at least one unshingled data region;
an LBA processing unit that dynamically allocates data stored in the shingled data region to the unshingled data region.

10. The system of claim 9, wherein the processing unit dynamically allocates the data based on a frequency of writes to an LBA range associated with the data.

11. The system of claim 9, wherein the LBA processing unit dynamically allocates the data based on a recency of a write operation performed to an LBA range associated with the data.

12. The system of claim 9, wherein the LBA processing unit initiates a write of the data to an unshingled data storage location.

13. The system of claim 9, wherein the LBA processing unit maps an LBA range corresponding to an unshingled data region to an LBA range corresponding to a shingled data region.

14. The system of claim 9, wherein the LBA processing unit initiates a write of data stored in the unshingled data storage location to a shingled data storage location.

15. One or more tangible computer-readable storage media encoding computer-executable instructions for executing on a computer system a computer process, the computer process comprising:
dynamically allocating data stored in a shingled data region of a magnetic media to an unshingled data region of the magnetic media.

16. The one or more computer-readable storage media of claim 15, wherein the computer process further comprises:
identifying the data to dynamically allocate based on a frequency of writes to an LBA range associated with the data.

17. The one or more computer-readable storage media of claim 15, wherein the computer process further comprises:
identifying the data to dynamically allocate based on a recency of a write operation performed to an LBA range associated with the data.

18. The one or more computer-readable storage media of claim 15, wherein dynamically allocating the data further comprises:
writing the data to an unshingled data storage location.

19. The one or more computer-readable storage media of claim 15, wherein dynamically allocating the data further comprises:
mapping an LBA range corresponding to an unshingled data region to an LBA range corresponding to a shingled data region.

20. The one or more computer-readable storage media of claim 15, wherein dynamically allocating the data further comprises:
writing data stored in the unshingled data storage location to a shingled data storage location.
